(19) United States
(12) Patent Application Publication
(10) Pub. No.: US 2012/0227850 A1
(43) Pub. Date: Sep. 13, 2012

(54) TUBE COUPLING FOR CONNECTING AN OBJECT TO ONE END OF A TUBE IN A UHV TIGHT MANNER AND VESSEL WITH SUCH A TUBE COUPLING

(75) Inventors: Alexander Howard, Zuerich (CH); Rico Chandrasekharan, Zuerich (CH); Giovanna Davatz, Zuerich (CH)

(73) Assignee: ARKTIS RADIATION DETECTORS LTD., Zuerich (CH)

(21) Appl. No.: 13/496,381

(22) PCT Filed: Sep. 16, 2009
(86) PCT No.: PCT/EP2009/006678

§ 371 Date: Jun. 4, 2012

(51) Int. Cl. F16L 19/00; F16L 55/11

(52) U.S. Cl. 138/89; 285/335

(57) ABSTRACT

The invention relates to a tube coupling (TC2) for connecting an object (22) to one end of a tube (20) in a UHV tight manner, withstanding pressures up to several hundred bars and accommodating temperature differences from heating or cooling, said tube coupling (TC2) comprising said tube (20) and a tube fitting (10), wherein said tube fitting (10) comprises a basically cylindrical body (11) with a first central bore for receiving said tube (20), such that said tube (20) is axially supported by a radially extending shoulder (18) at the inner end of said first central bore, and wherein said tube (20) is pressed with its end face against said radially extending shoulder (18) by means of a gripping arrangement (13, 14, 15). The vacuum capability is achieved with simple components by providing a gasket (21) between said end face of said tube (20) and said radially extending shoulder (18) at the inner end of said first central bore (16).

The present invention provides a solution especially for the sealing of windows or basically cylindrically shaped objects of vessels or chambers in a way compatible with ultra-high vacuum (UHV) as well as high pressure requirements, capable of accommodating temperature differences including cooling to cryogenic temperatures as well as heating as is typically performed in UHV applications, thus allowing a simple, practical and cost-effective way to fabricate devices that require such a seal, such as gas scintillation radiation detectors.

Industry offers a number of standardized components to assemble tube work capable of withstanding pressures up to a few hundred bars while at the same time being compatible with the requirements of ultra-high vacuum (UHV) preparation allowing high purity standards. VCR®-type fittings are an example of such components; they are however limited to small diameter tubing. For larger diameter tubing, knife-edge type seals are sometimes used.

Double-ferrule fittings (see for example U.S. Pat. No. 4,915,427 or WO-A1-2009/023505) allow the use of tubes of outer diameters including two inches, albeit at the price of a seal less suited for ultra-high vacuum application as it is prone to virtual leaks. However, if those virtual leaks in such double ferrule fittings could be avoided, these fittings could play a valuable role as a UHV compatible face seal without requiring modification of the parts involved.

Further, no industry standard processes exist that allow providing tube assemblies with windows in a manner capable of sustaining pressure while at the same time being compatible with UHV requirements. Examples for special non-standard window designs can be found in U.S. Pat. No. 4,986,636 or U.S. Pat. No. 5,773,841.

It is the object of the present invention to provide a simple, easy-to-use UHV-tight and pressure-tight tube coupling, capable of withstanding large temperature variations, based on simple components and procedures, thus allowing several applications including fabrication of gas based radiation detection equipment for measuring scintillation with respective optical windows.

The tube coupling according to the invention comprises a tube and a tube fitting, wherein said tube fitting comprises a basically cylindrical body with a first central bore for receiving said tube, such that said tube is axially supported by a radially extending shoulder at the inner end of said first central bore, and wherein said tube is pressed with its end face against said radially extending shoulder by means for applying an axial force to said tube, whereby a gasket is provided between said end face of said tube and said radially extending shoulder at the inner end of said first central bore.

According to one embodiment of the invention, said means for applying an axial force is a gripping arrangement of the double ferrule type. Such gripping arrangements may be mounted prior to assembly by using a hydraulic or pneumatic swaging device. It is an advantage of this embodiment that standardized components can be used with little or no modifications.

According to another embodiment of the invention, said tube rests with its end face against said radially extending shoulder at the inner end of said first central bore, such that said gasket is pressed between said end face and said radially extending shoulder.

According to another embodiment of the invention, a disc-shaped object is placed between said end face of said tube and said radially extending shoulder at the inner end of said first central bore, and said gasket is arranged and pressed between said disc-shaped object and said end face of said tube, such that said tube is closed by said disc-shaped object in a vacuum-tight and pressure-tight manner.

According to another embodiment of the invention, said disc-shaped object is an optical window.

According to another embodiment of the invention, said optical window is made of one of quartz, glass, fused silica, MgF₂ or sapphire.

The axial force on the gasket or window may be monitored. For example, by measuring the torque applied to a nut, which generates the axial force.

According to another embodiment of the invention, said gasket is made of a malleable material, in particular of gold, indium, lead, tin, platinum, copper, a fluoroelastomer (e.g. Viton®) or PTFE. Said gasket may have the form of a ring, wire or band.

According to another embodiment of the invention, said gasket is a composite sealing ring.

According to another embodiment of the invention a cushion of a material such as copper or indium is provided between said window and radially extending shoulder at the inner end of said first central bore.

The seal can be made between window and tube as described above, or analogously between window and radially extending shoulder, or if desired, in both locations.

According to another embodiment of the invention, said disc-shaped object is used as a termination of a chamber, an axial fixation, or a feed-through.

According to another embodiment of the invention said means for applying an axial force comprises an increase in the outer diameter of said tube, achieved by welding, gluing, clamping, brazing, or by machining said tube to such specifications.

Further, according to the invention, a vessel that can be evacuated to a desired vacuum and filled with gas to a desired pressure and/or heated or cooled to a desired temperature, is provided, whereby at least one tube coupling according to invention is arranged at said vessel as a vacuum tight and pressure tight access to said vessel.

According to one embodiment of the vessel according to the invention, a disc-shaped object is placed between said end face of said tube and said radially extending shoulder at the inner end of said first central bore, and said gasket is arranged and pressed between said disc-shaped object and said end face of said tube, such that said tube is closed by said disc-shaped object in a vacuum-tight and pressure-tight manner, whereby said disc-shaped object is an optical window, and is especially made of one of quartz, glass or sapphire.

According to another embodiment of the invention, means for receiving optical, infrared or ultraviolet radiation are placed on the side of the window opposite to said tube.

According to another embodiment of the invention, said optical radiation receiving means comprises one of a photomultiplier tube (PMT), solid state light detector, avalanche diode, multichannel plate, image intensifier, charge-coupled device or optical concentration sensor.

According to another embodiment of the invention, said vessel is filled with a gas, in particular a noble gas. Alternatively, nitrogen may be used. Especially, said vessel may be filled with a gas at cryogenic temperatures. Furthermore, said vessel may be filled with a liquid scintillator.

According to another embodiment of the invention, said vessel is filled with a noble gas such as xenon for gamma detection purposes or with a noble gas such as ⁴He or ³He for neutron detection purposes, or with a mixture of any of said gases, and is part of a radiation detector.

Alternatively, said vessel may be filled with a noble gas such as xenon for gamma detection purposes or with a noble gas such as argon, neon or krypton, or with a mixture of any of said gases, and is part of a radiation detector.

Furthermore, the walls of said vessel and/or the windows of said vessel may have a wave-length-shifting (WLS) material deposited thereon, or the said walls may have a WLS-coated liner, and said vessel is part of a radiation detector.

According to another embodiment of the invention, said vessel comprises a central tube, at both ends of which a tube coupling is provided, wherein a disc-shaped object is placed between said end face of said tube and said radially extending shoulder at the inner end of said first central bore, and said gasket is arranged and pressed between said disc-shaped object and said end face of said tube, such that said tube is closed by said disc-shaped object in a vacuum-tight and pressure-tight manner, whereby said disc-shaped object is an optical window, and is especially made of one of quartz, glass, fused silica, MgF₂ or sapphire.

The invention now shall be explained on the basis of various embodiments and with reference to the drawings.

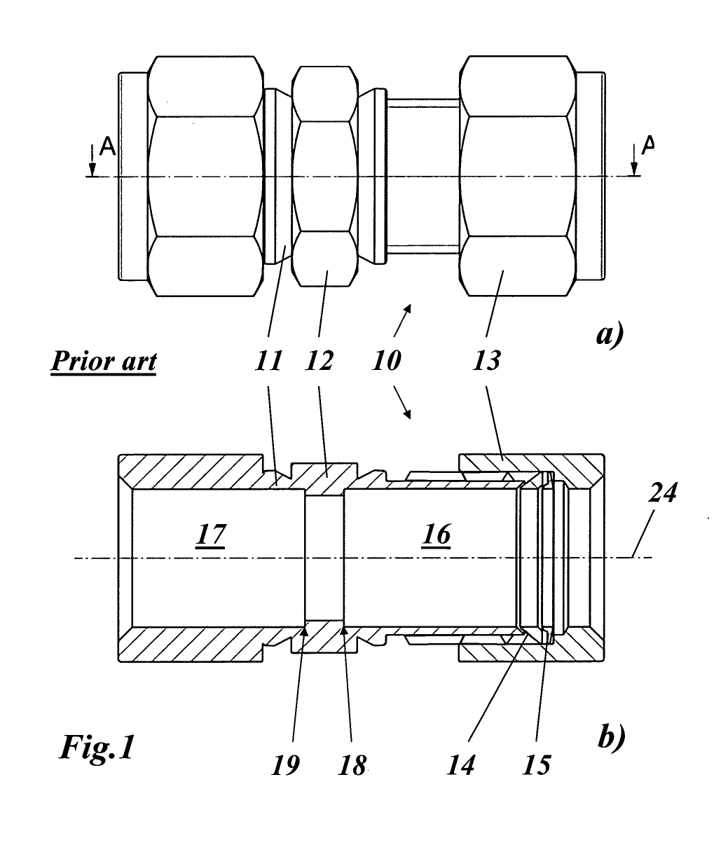

FIG. 1 shows a side view (FIG. 1a) and a longitudinal cross section in the plane A-A (FIG. 1b) of a well-known tube fitting with a gripping arrangement of the double ferrule type, which can be used for the tube coupling according to the invention;

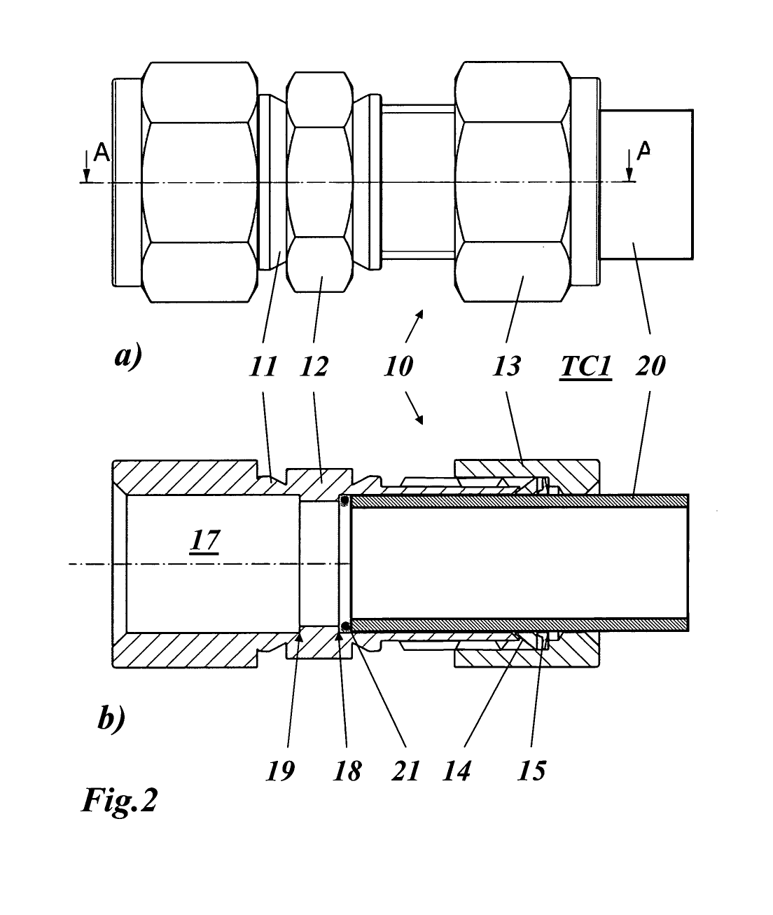

FIG. 2 shows a side view (FIG. 2a) and a longitudinal cross section (FIG. 2b) of a tube coupling according to a first embodiment of the invention, which is based on a tube fitting according to FIG. 1, in a mounting state before the gasket is compressed;

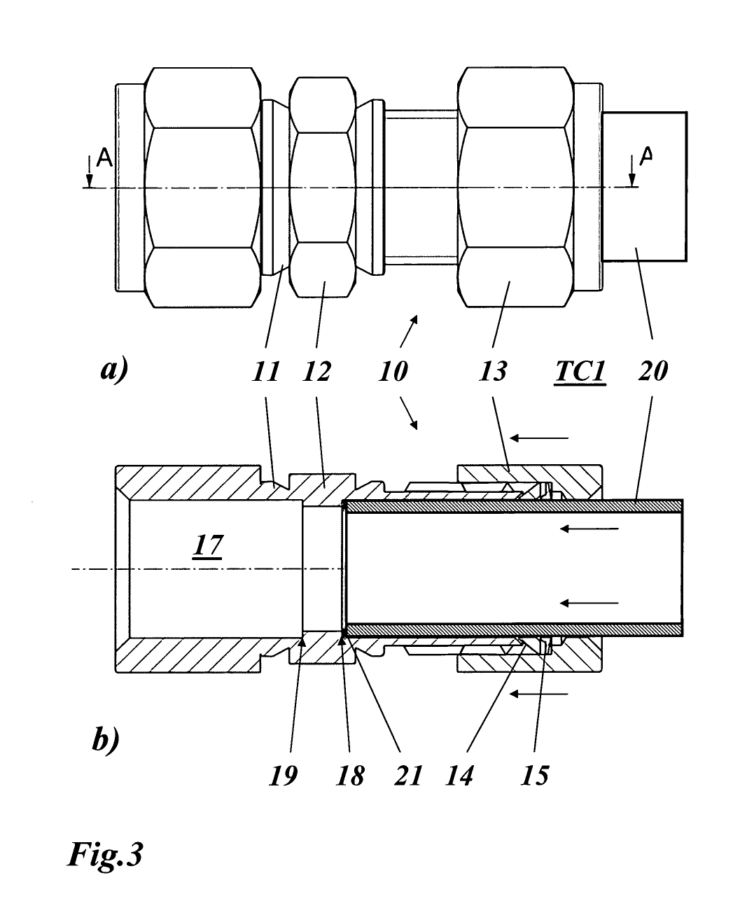

FIG. 3 shows a side view (FIG. 3a) and a longitudinal cross section (FIG. 3b) of the tube coupling according to FIG. 2 in the finished mounting state;

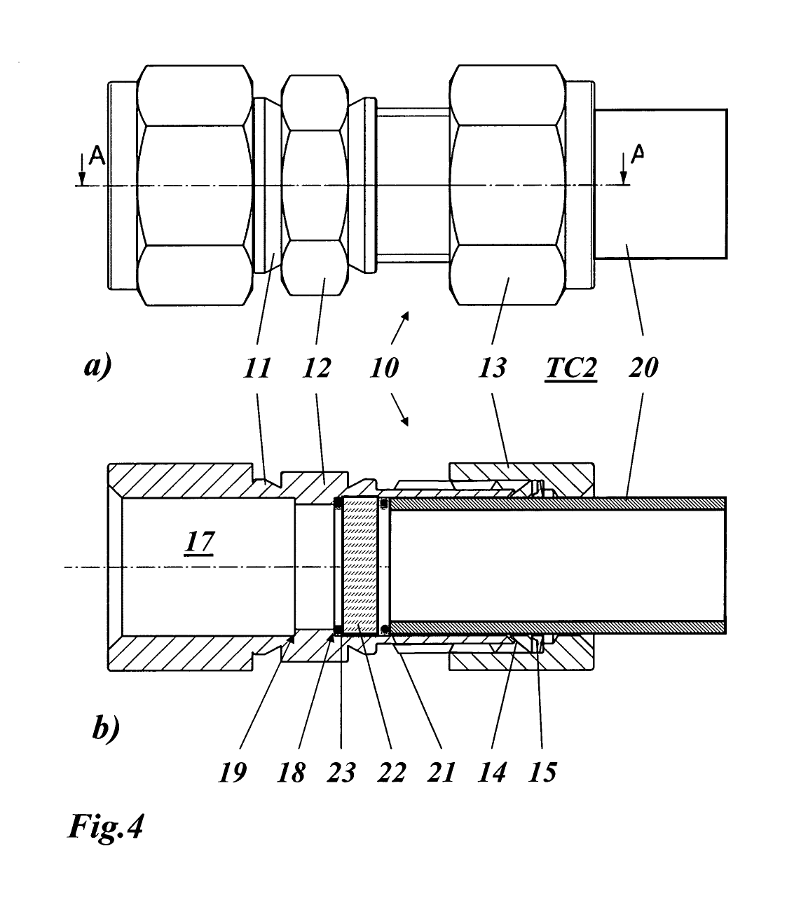

FIG. 4 shows a side view (FIG. 4a) and a longitudinal cross section (FIG. 4b) of a tube coupling according to a second embodiment of the invention, which is based on a tube fitting according to FIG. 1 and comprises an optical window, in a mounting state before the gasket is compressed;

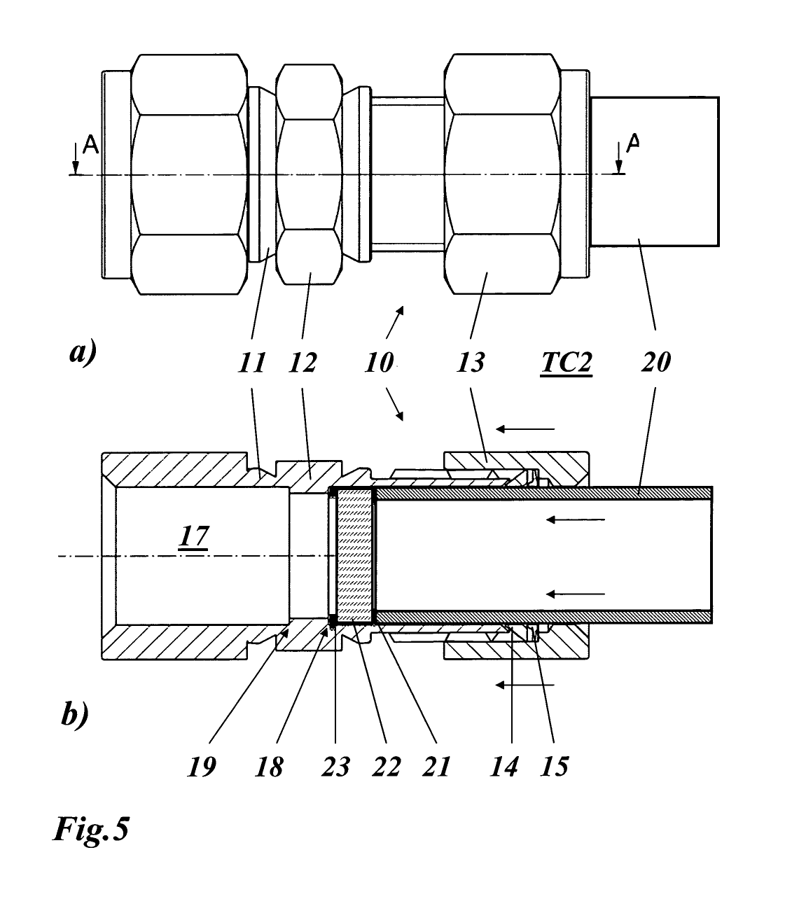

FIG. 5 shows a side view (FIG. 5a) and a longitudinal cross section (FIG. 5b) of the tube coupling according to FIG. 4 in the finished mounting state; and

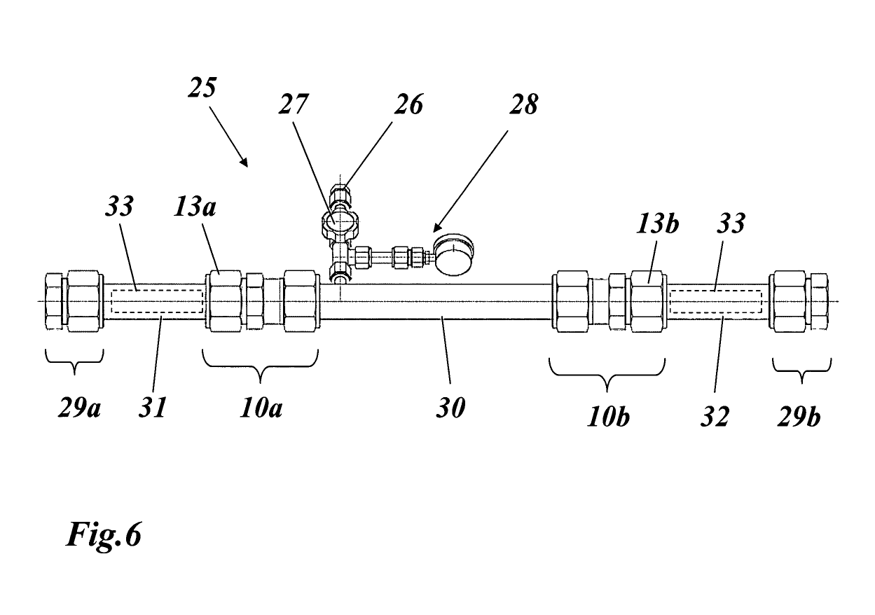

FIG. 6 shows a radiation detector arrangement with a central tube, which is closed at both ends by means of tube couplings according to the invention comprising optical windows, and which is filled with a noble gas to detect radiation with optical sensing means trough said windows.

FIG. 1 shows a side view (FIG. 1a) and a longitudinal cross section (FIG. 1b) of a well-known tube fitting 10 with a gripping arrangement of the double ferrule type, which can be used for the tube coupling according to the invention. The tube fitting 10 comprises a basically cylindrical body 11 with an axis 24 and two axially extending bores 16 and 17 of a first inner diameter, which are connected by a counter-piece 12 with a second inner diameter, which is smaller than the first inner diameter. Due to the step in the inner diameter two shoulders 18 and 19 exist at the inner end of the bores 16 and 17. The shoulders 18 and 19 act as a stop, when a tube with an outer diameter similar to the inner diameter of the bores 16, 17 is axially introduced into said bores (see FIG. 2).

The tube fitting 10 is provided with a gripping arrangement, which comprises two concentrical ferrules 14 and 15 and a cap nut 13, which interacts with a respective outside thread on the body 11. The function of this double ferrule gripping arrangement is well-known in the art (see for example WO-A2-2007/087043). The tube fitting 10 of FIG. 1 is shown with a gripping arrangement 13, 14, 15 only on the right side of the fitting. However, the tube fitting may be equipped with such a gripping arrangement at both sides in a symmetrical way, so that two tubes may be removably connected, by means of a left and right double-ferrule arrangement and left and right cap nuts.

Now, a standard tube fitting like the one shown in FIG. 1 is used to establish a UHV tight tube coupling according to the invention. This is done by substantially changing the sealing process and configuration: The sealing between the tube and the fitting is no longer based on the double ferrules 14, 15, which cut into the outside of the tube, as such sealing would have the severe disadvantage, that the circular gap between the tube and the inner wall of the bore 16 is connected to and part of the internal space of the tube and serve as a virtual leak during evacuation. In fact, an effective and UHV compatible sealing is achieved by providing a compressible gasket between the end face of the tube and the respective shoulder 18 (or 19) at the end of the bore 16 (or 17).

FIG. 2 shows a tube coupling TC1 according to these principles: Tube coupling TC1 comprises a tube 20 and a tube fitting 10 of the double-ferrule type, as shown in FIG. 1. The tube may have an outer diameter of 2″ (50.8 mm) and a wall thickness of 0.188″ (4.78 mm), for example. A wire of indium (or another suitable metal or metal alloy or polymer), whose ends may be joined together or left overlapping, forms a gasket 21, which separates the counter-piece 12 and the tube end. The gasket 21 is not yet compressed. Tightening the cap nut 13 relative to the counter piece 12 creates an axial force compressing the indium gasket 21 and forming a UHV tight and pressure tight seal. For evacuation purposes the coupling TC1 may be heated up to 150° C. It may withstand pressures between 0 and 200 bar. The axial force applied may be quantified via the torque applied to said cap nut, which torque may be in the range of between 100 Nm and 1000 Nm. FIG. 3 shows the seal of FIG. 2 in its tightened state.

While FIGS. 2 and 3 relate to a simple seal between the tube and the fitting, the same sealing configuration may be used to hermetically close the end of the tube with a disc-shaped object, especially an optical window. This is shown in FIGS. 4 and 5.

FIG. 4 shows a tube coupling TC2 with a tube 20 and a tube fitting 10 according to double-ferrule principle. A disc-shaped object 22 is lodged between the tube 20 and the counter piece 12 of the fitting 10. In the embodiment shown, a cushion 23 separates the fitting counter-piece 12 and the disc-shaped object 22, while a wire of indium as a gasket 21 again separates the disc-shaped object 22 and the tube end. Doing up the cap nut 13 relative to the counter piece 12 creates an axial force compressing the gasket 21 and forming a seal. FIG. 5 shows the seal of FIG. 4 in its done-up state. It is well within the scope of the invention to place the gasket 21 either between the window 22 and the tube 20, as described above, or analogously between the window 22 and the radially extending shoulder 18, or if desired, in both locations, i.e. between the window 22 and the tube 20 and between the window 22 and the radially extending shoulder 18.

Now, to create a UHV tight and pressure tight vessel or chamber with an optical access from opposing sides, a tube can be sealed with a window on both ends according to FIG. 4 or 5 (see FIG. 6). A VCR®, NPT or other suitable connection may be welded or otherwise attached to the tube. This connection allows the evacuation of the tube to ultra-high vacuum, as well as the filling of the tube with a desired gas at a desired pressure. Furthermore, industry standard end caps may be provided at both ends (on the left side of tube fitting 10 of FIG. 1, by means of an external thread), to create containment areas at both ends. These containment areas serve the purpose of avoiding injury in case of a window or seal failure under pressure. When the tube is filled with noble gas and photo sensors are arranged outside the windows in each of the containment areas, the configuration can serve as a radiation detector.

It is evident, that the tube fitting 10 of FIG. 1 may be modified to include a deeper bore 16 to accommodate for a fairly thick window, as well as a broader shoulder 18 to support the window 22 better and thus allow higher pressures.

FIG. 6 shows a radiation detector 25 according to the principles explained above. A central tube 30 is closed at both ends with optical windows by means of tube fittings 10a and 10b similar to FIGS. 4 and 5, but with second cap nuts 13a and 13b for extending tubes 31 and 32, which are closed at their respective ends by fittings 29a and 29b. The extending tubes 31 and 32 act as containment areas and are big enough to accommodate photomultiplier tubes 33 (dashed lines in FIG. 6). The central tube 30 is accessible by a VCR® port 26 via a valve 27. A pressure gauge 28 is connected to the port 26 to monitor the gas pressure within the central tube 30.

A radiation detector 25 of the kind shown in FIG. 6 may used in a method for monitoring an unknown container or contents in a volume, as disclosed in WO-A2-2007/121876. A plurality of radiation detectors 25 may be arranged in a parallel array in accordance with FIG. 5 to 8 of the document to allow for the differentiation of radiation-emitting point-sources from spread-out sources, analyze the content by means of its radiation's energies, radiation types, radiation directions, and timing of emission.

Various modifications of the tube coupling explained above are conceivable within the scope of the invention:

The tube fittings 10 or 10a,b may be pre-mounted using a swaging device.

Furthermore, the end of the tubing may be modified in terms of shape, for example with a groove, a knife-edge or with different diameters than the rest of the tubing, or the counter-piece 12 may be modified in terms of shape, for example having a deeper bore to accommodate a thicker window or having a different ledge design to allow higher operation pressures, or being angled to accommodate windows with frustum shapes, or otherwise specially designed.

Flanges may be used in place of pipe fittings to compress the gasket.

One side (referred to as the process area) of the disc-shaped object 22 may be subject to vacuum and or pressure of gases of choice, the other side of the disc shaped object (referred to as the containment area) may be enclosed in a way so that in the event of a failure of the seal or the disc shaped object, such a failure will not affect areas outside of the containment areas. For example, should a seal fail under high-pressure, such a failure will not lead to the expulsion of gas or fragments outside the containment area.

The primary application, for which the tube coupling was developed, is gas based scintillation detectors. Such devices can consist of pressurized noble gas of high purity and windows that allow scintillation light to pass from the gas to photo sensors such as photomultiplier tubes (PMT) on the other side of such windows (see the WO-A2-2007/121876). The invention is beneficial to this application since it provides an efficient way to fabricate radiation detection modules largely out of standard low-cost off-the-shelf components. Other potential applications of the invention include the fabrication of optical concentration sensors, high pressure metal vapour lamps, and lasers.

### LIST OF REFERENCE NUMERALS

10,10a,b tube fitting
11 body
12 counter-piece
13,13a,b cap nut
14,15 ferrule
16,17 bore
18,19 stop (shoulder)
20 tube
21 gasket (e.g. Indium wire)
22 disc-shaped object (e.g. window)
23 cushion
24 axis
25 radiation detector
26 port
27 valve
28 pressure gauge
29a,b fitting
30 central tube
31,32 tube (photomultiplier housing)
33 photomultiplier
TC1,2 tube coupling

1. Tube coupling for connecting an object to one end of a tube in a UHV tight manner, withstanding pressures including several hundred bars, said tube coupling comprising:
said tube and a tube fitting, wherein
said tube fitting comprises:
a basically cylindrical body with a first central bore for receiving said tube, such that said tube is axially supported by a radially extending shoulder at the inner end of said first central bore, and wherein
said tube is pressed with its end face against said radially extending shoulder via a gripping arrangement which applies an axial force to said tube, wherein a gasket is provided between said end face of said tube and said radially extending shoulder at the inner end of said first central bore.

2. The tube coupling according to claim 1, wherein said gripping arrangement comprises a double ferrule.

3. The tube coupling according to claim 1, wherein said tube rests with its end face against said radially extending shoulder at the inner end of said first central bore, such that said gasket is pressed between said end face and said radially extending shoulder.

4. The tube coupling according to claim 1, wherein a disc-shaped object is placed between said end face of said tube and said radially extending shoulder at the inner end of said first central bore, and in that wherein said gasket is arranged and pressed between said disc-shaped object and said end face of said tube, such that said tube is closed by said disc-shaped object in a vacuum-tight and pressure-tight manner.

5. The tube coupling according to claim 4, wherein said disc-shaped object is an optical window.

6. The tube coupling according to claim 5, wherein said optical window is made of one of quartz, glass, fused silica, MgF2 or sapphire.

7. The tube coupling according to claim 1, wherein said gasket is made of a malleable material.

8. The tube coupling according to claim 1, wherein said gasket is a composite sealing ring.

9. The tube coupling according to claim 5, wherein a cushion of a material such as copper is provided between said window and radially extending shoulder at the inner end of said first central bore.

10. The tube coupling according to claim 4, wherein said disc-shaped object is used as a termination of a chamber, an axial fixation, or a feed-through.

11. The tube coupling according to claim 4, wherein said gripping arrangement comprises an increase in the outer diameter of said tube, achieved by welding, gluing, clamping, brazing, or by machining said tube to such specifications.

12. A vessel that can be evacuated to a desired vacuum and filled with gas to a desired pressure and/or heated or cooled to a desired temperature, wherein at least one tube coupling (TC1, TC2) according to claim 1 is arranged at said vessel as a vacuum tight and pressure tight access to said vessel.

13. The vessel according to claim 12, wherein said at least one tube coupling wherein a disc-shaped object in form of an optical window is placed between said end face of said tube and said radially extending shoulder at the inner end of said first central bore, and wherein said gasket is arranged and pressed between said disc-shaped object and said end face of said tube, such that said tube is closed by said disc-shaped object in a vacuum-tight and pressure-tight manner.

14. The vessel according to claim 13, wherein radiation receiving device(s) which receives optical, infrared or ultraviolet radiation are placed on the side of the window opposite to said tube.

15. The vessel according to claim 14, wherein said optical radiation receiving device(s) comprises one of a photomultiplier tube (PMT), solid state light detector, avalanche diode, multichannel plate, image intensifier, charge-coupled device or optical concentration sensor.

16. The vessel according to claim 12, wherein said vessel is filled with a gas, in particular a noble gas.

17. The vessel according to claim 14, wherein said vessel is filled with xenon for gamma detection purposes or with helium for neutron detection purposes, or with a mixture thereof, and is part of a radiation detector.

18. The vessel according to claim 13, wherein said vessel comprises a central tube, at both ends of which a tube coupling (TC2) is provided, wherein a disc-shaped object in form of an optical window is placed between said end face of said tube and said radially extending shoulder at the inner end of said first central bore, and wherein said gasket is arranged and pressed between said disc-shaped object and said end face of said tube, such that said tube is closed by said disc-shaped object in a vacuum-tight and pressure-tight manner.

19. The tube coupling according to claim 7, wherein the malleable material material is gold, indium, lead, tin, platinum, copper, a fluoroelastomer or PTFE.

20. The tube coupling according to claim 7, wherein the fluoroelastomer is VITON.
